(19) United States
(12) Patent Application Publication
(10) Pub. No.: US 2017/0004401 A1
(43) Pub. Date: Jan. 5, 2017

(54) ARTIFICIAL INTUITION

(71) Applicants: Alexandr Igorevich Kolotygin, Taschkent (UZ); Andrey Victorovich Akayomov, Taschkent (UZ)

(72) Inventors: Alexandr Igorevich Kolotygin, Taschkent (UZ); Andrey Victorovich Akayomov, Taschkent (UZ)

(21) Appl. No.: 14/833,505

(22) Filed: Aug. 24, 2015

(30) Foreign Application Priority Data
Jun. 30, 2015 (RU) 2015125952

(51) Int. Cl. G06N 5/02

(52) U.S. Cl. CPC G06N 5/022

(57) ABSTRACT

The invention relates to intelligent systems, i.e., computer models of artificial intuition, and is designed for the objects' model automated creation based not on the properties similarity, but on the response to external actions. The technical result of the invention is a reality model building (consistent and coherent model of the studied object), which is described by the sets of links between the object elements for solving various tasks of information intelligent processing, including approximation and interpolation, recognition and classification of images, data compression, prediction, identification, control, association, and so forth.

### CROSS-REFERENCE TO RELATED APPLICATIONS

This application claims priority to Russian Patent Application No. 2015125952, filed Jun. 30, 2015, the entire disclosure of which is expressly incorporated herein by reference.

### FIELD OF THE INVENTION

The invention relates to intelligent systems, including computer models of artificial intuition, and is designed for the objects' model automated creation based not on the properties similarity, but on the response to external actions.

### BACKGROUND OF THE INVENTION

### Sources of Literature

1. A. V. Gavrilov. Hybrid Intelligent Systems: Monograph—Novosibirsk: Novosibirsk State Technical University publishing office, 2002.-142 p.
2. Haykin, Simon. Neural Networks: Complete Course, 2nd Edition: translation from English-Moscow: Publishing House “Williams”, 2006.-1104 p.

### SUMMARY OF THE INVENTION

The invention relates to intelligent systems, i.e., computer models of artificial intuition, and is designed for the objects' model automated creation based not on the properties similarity, but on the response to external actions. The technical result of the invention is a reality model building (consistent and coherent model of the studied object), which is described by the sets of links between the object elements for solving various tasks of information intelligent processing, including approximation and interpolation, recognition and classification of images, data compression, prediction, identification, control, association, and so forth. The technical result is achieved by applying the method of computer-aided object model creation that comprises the stages at which:

1) Referenced object is split into parts, which are the concepts that have identical data sets describing their characteristics; whereas the concepts are formed on the basis of predetermined rules of ungrouping and, if required, the concepts containing the identical or close property values are reduced.

2) Primary data is obtained, which represent all existing pairs of the referenced object parts in the amount of (n*n)/2−n, where n means the number of parts.

3) Evaluation and optimization of number of properties among those that describe the referenced parts of the object are performed.

4) Functional processing of the obtained rows is made, whereas the standard set of functions is used; in particular, correlation or root-mean-square difference, or specific functions arising out of task setting logic are applied.

5) Obtained results are sorted and grouped, whereupon the grouped data is verified subject to their redundancy, and then the procedure of grouped data normalization is executed, during which the redundant data is filtered out.

6) Functional links between the normalized grouped data obtained by different ways applying intellectual processing are built with the use of expert system (ES) operation.

7) Data pairs, which when processed by various functions provide a close or predictable result, are determined as linked and subsequently are used for object model building.

8) Following information is determined: which functions have been applied to analyse the links between the parts of the modelled object, which links between the parts thereof are the strongest, which links are generated by the largest number of functions that differ the most from each other, which concept is the most frequently present in the upper and lower positions of the pairs list sorted by values of various functions, distribution function nature for different concepts; and correlated and non-significant properties are identified.

9) They determine, if the obtained model provides a predictable result, then it is deemed as created: if the obtained result does not meet the imposed requirements, then it is deemed preliminary and used to modify the rules of ungrouping, estimation of properties, selection of functions for processing, and filtering criteria; if there is no result, then the number of properties and accuracy of their evaluation are analysed, and specific functions of data pairs processing are replaced with the standard ones.

In accordance with one embodiment of the present invention, a method of object model computer creation is provided, comprising the steps of:

1) splitting a referenced object into parts, which are the concepts that have identical data sets describing their characteristics, wherein the concepts are formed on the basis of predetermined rules of ungrouping and, if required, the concepts containing the identical or close property values are reduced;

2) obtaining primary data, which represents all existing pairs of the referenced object parts in the amount of (n*n)/2−n, wherein n represents the number of parts;

3) evaluating and optimizing a number of properties, including those that describe the referenced parts of the object are performed;

4) functionally processing the obtained rows, wherein a standard set of functions is used including correlation or root-mean-square difference or specific functions arising out of task setting logic are applied;

5) sorting and grouping obtained results, wherein the grouped data is verified subject to their redundancy, and then the procedure of grouped data normalisation is executed, during which the redundant data is filtered out;

6) building functional links between the normalised grouped data obtained by different ways applying intellectual processing with the use of an expert system operation;

7) determining data pairs, which when processed by various functions provide a close or predictable result, as linked and subsequently are used for object model building;

8) determining which functions have been applied to analyse the links between the parts of the modelled object, which links between the parts thereof are the strongest, which links are generated by the largest number of functions that differ the most from each other, which concept is the most frequently present in the upper and lower positions of the pairs list sorted by values of various functions, distribution function nature for different concepts, and correlated and non-significant properties are identified; and

9) determining if the obtained model provides a predictable result, then it is deemed as created, if the obtained result does not meet the imposed requirements, then it is deemed preliminary and used to modify the rules of ungrouping, estimation of properties, selection of functions for processing, and filtering criteria, if there is no result, then the number of properties and accuracy of their evaluation are analysed, and specific functions of data pairs processing are replaced with the standard ones.

In accordance with one aspect of this embodiment, an artificial neural network is used at stage 5).

In accordance with one aspect of this embodiment, the rules of data cooperative processing for the expert system and artificial neural network are applied.

In accordance with one aspect of this embodiment, the artificial neural network has an optimised architecture for accumulation of processing results for the purpose of establishing the dependencies and regularities between the distribution of different functions results values at different parameters and fixed data.

In accordance with one aspect of this embodiment, the rules of cleaning, rules of grouping, rules of data cooperative processing for the expert system, rules of norming and rules of analysis are developed with the possibility make an adapted change during the iterative process of the studied object model building.

In accordance with another embodiment of the present invention, a system of object model computer creation is provided containing at least one or more processors, and at least one memory device, where at least one memory device stores machine-readable instructions, which, if executed by at least one processor, stimulate the processor to execute the method of the object model creation according to above-described method.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Embodiments of the present invention are illustrated in the figures of the accompanying drawings. The figures are provided to aid thorough understanding of the invention and are exemplary rather than limiting. Based on the present teachings, person of ordinary skill in the art can contemplate various alternatives, variations and modifications to the illustrated embodiments within the scope of the invention disclosed herein.

The invention will now be described in relation to the accompanying drawings, in which:

FIG. 1 illustrates the flowchart of an artificial intuition computer model operation; and

FIG. 2 and FIG. 3 depict the geometry of a single-layer perceptron of an artificial intuition computer model prior and upon the training.

### DETAILED DESCRIPTION OF THE INVENTION

The specific embodiments of the present invention are described below in greater detail. The following description of the specific embodiments refers at various places to the accompanying drawings and specific environments, applications, platforms, examples, computer screenshots, and implementations. Such description is provided for thorough understanding of the present invention and is illustrative rather than limiting.

As of today, the present invention has no analogues that reveal the generic aspects of the applied approach.

The present invention relates to the class of intuitive systems, and in fact is the one and only technical materialization of artificial intuition.

An objective of this invention consists in creation of a wholly new method of information models generation, which is the artificial intuition by virtue of its nature.

The technical result of the invention is reality model building (consistent and coherent model of the studied object), which is described by the sets of links between the object elements for solving various tasks of information intelligent processing, including approximation and interpolation, recognition and classification of images, data compression, prediction, identification, control, association, etc. At the same time, the obtained models can be purpose-designed for a specific task, but in either case a model is used to solve the task, but is not its solution by itself. And since the versions of building even specific models can be really numerous, the criteria of selecting from them shall be brought into conformity with task requirements; they can be, for instance, those which allow an unambiguous visualisation, or make it possible to pass the subsequent processing within a hybrid intelligent system (neural network+expert system) at the least cost for computing operations, or those that ensure the highest accuracy of calculations, or provide the best prediction. This means that we have a bundle of artificial intuition+intelligence (natural or artificial). The intuition here serves to mark out the critical objects by monitoring the regularity between various alternatives of processing relations between them, and the intelligence predicts their evolution and behaviour when conditions are modified. At this, the efficiency of the intellectual component is achieved not by the way of its getting more complicated or more specific, but rather by the fact that the intuitive part of the system keeps the high degree of freedom (accuracy, number, pertinence) in terms of output data presentation.

The technical result is achieved by applying the method of computer-aided object model creation that comprises the stages at which:

Referenced object is split into parts, which are the concepts that have identical data sets describing their characteristics; whereas the concepts are formed on the basis of predetermined rules of ungrouping and, if required, the concepts containing the identical or close property values are reduced.

Primary data is obtained, which represent all existing pairs of the referenced object parts in the amount of (n*n)/2−n, where n means the number of parts.

Evaluation and optimization of number of properties among those that describe the referenced parts of the object are performed.

Functional processing of the obtained rows is made, whereas the standard set of functions is used; in particular, correlation or root-mean-square difference, or specific functions arising out of task setting logic are applied.

Obtained results are sorted and grouped, whereupon the grouped data is verified subject to their redundancy, and then the procedure of grouped data normalization is executed, during which the redundant data is filtered out.

Functional links between the normalized grouped data obtained by different ways applying intellectual processing are built with the use of expert system (ES) operation).

Data pairs, which when processed by various functions provide a close or predictable result, are determined as linked and subsequently are used for object model building.

Following information is determined: which functions have been applied to analyze the links between the parts of the modelled object, which links between the parts thereof are the strongest, which links are generated by the largest number of functions that differ the most from each other, which concept is the most frequently present in the upper and lower positions of the pairs list sorted by values of various functions, distribution function nature for different concepts; and correlated and non-significant properties are identified.

They determine, if the obtained model provides a predictable result, then it is deemed as created; if the obtained result does not meet the imposed requirements, then it is deemed preliminary and used to modify the rules of ungrouping, estimation of properties, selection of functions for processing, and filtering criteria; if there is no result, then the number of properties and accuracy of their evaluation are analysed, and specific functions of data pairs processing are replaced with the standard ones.

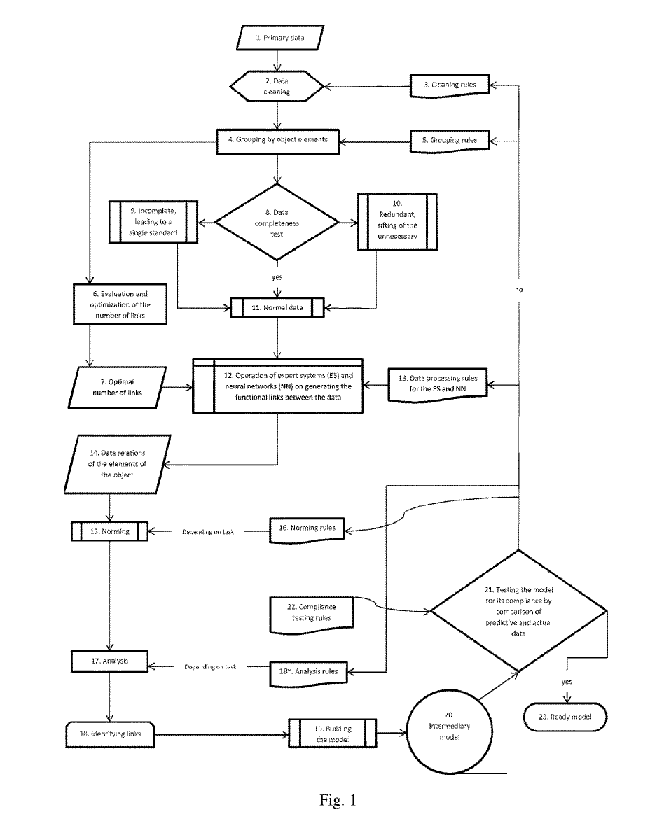

FIG. 1 illustrates the flowchart of an artificial intuition computer model operation.

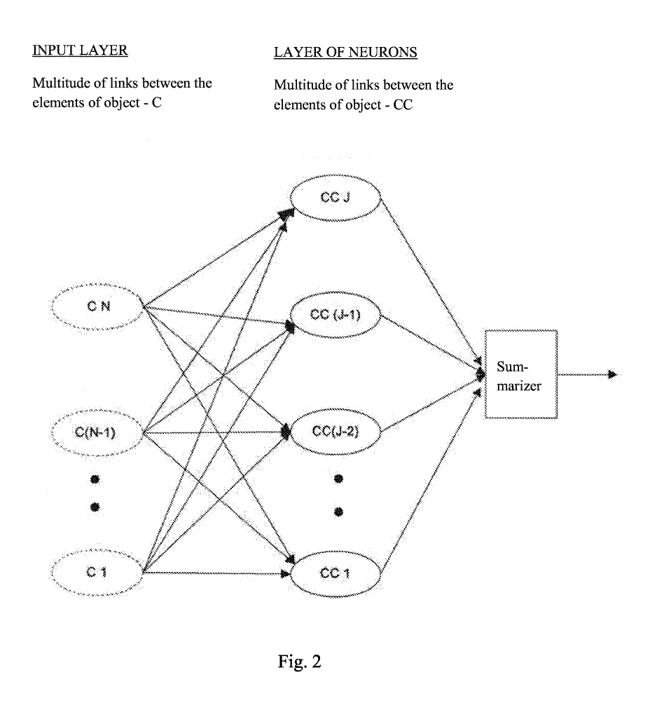

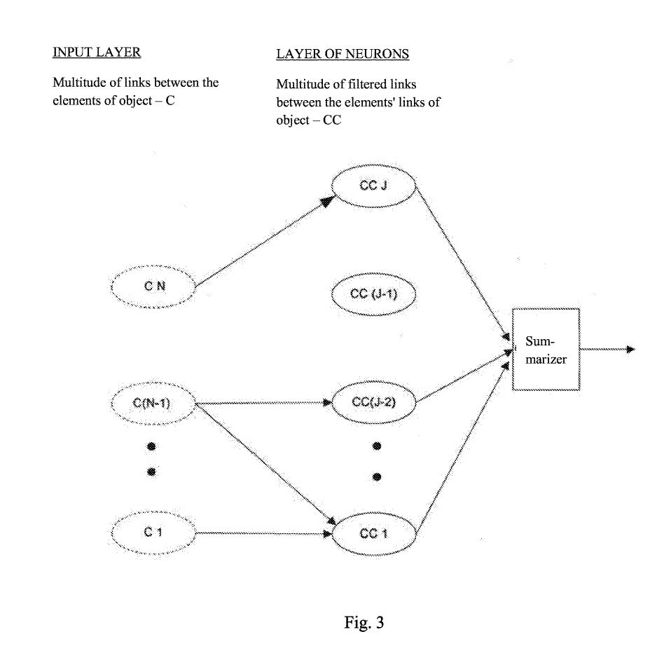

FIG. 2 and FIG. 3 depict the geometry of a single-layer perceptron of an artificial intuition computer model prior and upon the training.

The invention relates to the intelligent systems—computer models of artificial intuition, and designed for the objects' model automated creation based not on the properties similarity, but on the response to the external actions, and the different features of links between its parts (object elements) are used as the input data by identifying the regularities among them with the purpose of searching for the relevant knowledge or, in other words, rebuilding of a fragment of knowledge (image) through its partial or noisy sample (see source 1).

As stated above, the applied solution embodies a bond of artificial intuition+intelligence (natural or artificial). At the same time, the intuition serves to distinguish the critical objects by monitoring the regularities between various ways of processing links among them, and the intelligence predicts their evolution and behaviour when conditions change; upon that the efficiency of the intellectual component is achieved not by its getting more complicated or more specific, but rather by the fact that the system intuitive part possesses a high level of freedom (accuracy, number, pertinence) in terms of output data provision. The links between the object's parts are much more numerous than the parts themselves; for example, during the processing of the paired links only, this variable will be (N*N−N)*K where N is the number of links, and K is the number of ways to process the links. Naturally, if this is required, not only the paired links can be considered, but also the links between the various methods of grouping object's parts.

Therefore, possessing the high data redundancy for the computation, applying various methods of grouping algorithm selection and subsequent filtration, we can easily adapt them for both the specific intelligent component and existing hardware limitations. As the task can be solved using various methods of privileges division between the computer—man system. Furthermore, both software applications and specific processors or analogue data processing systems can be used to solve the task.

The intellectual processing tasks are understood as, for instance, approximations and interpolations, recognition and classification of images, data compression, prediction, identification, control, association, etc.

The task of creation of the studied object model described by the sets of links between the object elements is very difficult in general. In many cases, a satisfactory model building cannot be implemented without participation of a human being, who uses the non-formalized attributes during the building, accumulated in the course of experience.

The computing machinery assisted information intellectual processing can make it easier for people to create the studied object's model. This processing is particularly efficient in the cases when a large number of elements of the studied object is available, or when a large number of data about the object is obtained. Full information on the object must be narrowed down to the form, which allows one to interpret optimally the obtained data. When the information about the object is prepared, many methods are applied to facilitate the understanding of the entity object by the human, including the theory of recognition.

Our analysis of the existing recognition methods with the help of artificial neural network (ANN) has detected undocumented opportunities in the field of information intellectual processing, and namely in the preliminary processing (preprocessing) of information transferred to the ANN neurons.

The fundamental difference of the artificial intuition computer model in the present invention is object model building with the use of the identified regularities within the links between the parts (elements) of the object that makes it possible to increase the accuracy in solving of complex object modelling tasks, as opposed to traditional analytical approach where the primary focus is made on the description of object elements. This combination of different methods of processing and truncation of insignificant values allows the identifying of various link types that subsequently can be applied to the creation, building or configuring of geometry of the experts systems and neural networks in which information about the internal links is clearly available within the geometry of a trained ANN type single-layer perceptron (see 2, p. 194) in contrast to the traditional multi-layer ANN (see. 2, p. 218), where the information about the internal links of the object is stored in a non-formalized form of the links between the neurons of different layers.

The artificial intuition computer model is focused on the solution of different tasks of information intellectual processing, including approximation and interpolation, recognition and classification of images, data compression, prediction, identification, control, association, etc., and as compared to the traditional methods, it is more efficient in the event of a non-complete or faulty source information.

The total of the invention above-mentioned signs is connected by a cause-and-effect link with the technical result of the invention. The object's final model is resulted from the operation of the artificial intuition computer model generated of the filtered according to the set parameters aggregation (synthesis) of control, central, stabilizing and other links between the object elements in such a way that in the issue the built model (image) of the object ensures the master similar response within the optimal range of user's computational capabilities.

FIG. 1 displays the sequence of actions executed during the implementation of the present method. The progress of solving tasks by the present method of artificial intuition is split on a series of steps combined in stages. At stage 1), the said object is split into parts (concepts) that are characterised by identical sets of data describing their characteristics (ungrouping), where the concepts are formed on the basis of predetermined rules of ungrouping and, if required, the concepts containing the same or similar property values are reduced (in some cases it is admissible to perform the preliminary calculation containing only some parts (concepts) of the object). Then at stage 2) the primary data is obtained (step 1), which represent paired links and/or the links about the studied object, where the object can represent the aggregate of splittable and non-splittable elements, characterised by the data set. The primary data constitute all existing parts of the said object parts in the amount of (n*n)/2−n, where n means the number of parts. The referred links represent numerical series, which characterize the properties of a specific object. Next, the primary data filtration is done (step 2) on the basis of the cleaning rules set (step 3), in the course of which insignificant data is excluded, and upon that the referred cleaning rules can be adaptively modified during the iterative process of building the studied object model. Cleaning rules depend on the object domain. For instance, for the format of geophysical data (frequency distribution) only maximums are considered. To analyze the fluctuations of goods or forex value through time, only maximums and minimums are considered. If experimental data that monitor variation of some values depending on the impact to object are operated, then the similar strings are excluded from the processing. At recognition of photographs, the green channel is considered only if an ambiguity occurs in the red channel, the blue one is not considered at all. Most often, the existing and well known condition of the studied object is sufficient for the development of the cleaning rule, but sometimes it is worth to experiment with various data sets. And if lesser number of data provides with more stable result, then this particular set is used further.

At stage 3), the evaluation and optimization of the number of properties among those that describe the parts of the object are performed. The studied object is split into elements (groups) (step 4), which are characterised by the identical data sets; the groups are formed on the basis of grouping rules (step 5) that can be adaptively variated in the course of the iterative process of building of the studied object model. The grouping rules are used for evaluation (step 6) and optimization (step 7) of the number of links between the object elements (groups). If the number of generated links imposes certain limitations related to the computational capabilities, then either grouping rules change, or various methods of their filtration are applied. At stage 4), functional processing of the obtained rows is made, where the standard set of functions is used, in particular, correlation or root-mean-square difference, or specialized functions are applied, which arise out of the problem statement logic. For instance, when de-noising the camera matrix, the most natural grouping method (rows-columns) provides an unacceptably large number of computations. Therefore, if there are details on matrix architecture, the grouping of elements can be performed in accordance with the rules that characterize the selection of pixels according to its structure. In reality, the achievement of the required effect is performed by taking photos of a grey sheet of paper—several times, in low light environment and with high ISO sensitivity, and upon that the statistics on the most frequently noisy pixels is collected, and subsequently, when a photo is cleaned, only the data from these spots are used.

At stage 5), the obtained results are sorted and grouped, whereupon the grouped data is verified subject to their redundancy, and then the procedure of grouped data normalization is executed, during which the redundant data is filtered out. For this purpose the obtained grouped data is verified subject to their completeness and redundancy (step 8), and if the fact of data non-completeness is established (step 9) the referred data is supplemented with the interpolated data, depending on the model of studied object, whereas in the fact of redundant data (step 10)—the grouped data normalization procedure is performed, at which the redundant data is filtered out. The data is considered as redundant, if they do not contain sensitive information. For example, pulse-pressure-body temperature must be measured, and to find out how these indicators react on taking of the medical drug. Let us assume that the measurements are taken at 10 minutes interval. If all three indicators did not cross the normal limits for any period of time, then they are not considered. If all indicators did not cross the normal limits, they considered incomplete, and criteria for analysis must be added. For instance, to measure respiration frequency and depth, or take the temperature in different parts of the body. And vice-versa, in certain cases it is worth occasionally to decrease some data as being insignificant or inter-related (such as respiration frequency and depth). When processing the samples from the patients with a specific illness, it is worth to compare the collected samples with the samples from healthy people to exclude subsequently from the processing those indicators, which this disease does not affect or affects very little. These are redundant data.

At stage 6), building of the functional links between normalized grouped data with the help of intellectual processing by artificial intuition computer model of expert system (ES) is executed, in the course of which, at least, pair-wise processing of homogeneous data by functions is performed according to the rules of ES data cooperative processing. The artificial neural network (ANN) can be used additionally for the processing, and in this case the rules of data cooperative processing for the ES and ANN will be applied. If the function for processing of links is single, then the ES sorting operation only is used. If the functions are several, then the ANN is included into operation, the architecture of which is optimized for accumulation of processing results for the purpose of establishing dependencies and regularities between the distribution of different functions results values at the different parameters and fixed data. The referred rules can change adaptively in the course of the iterative process of studied model object building. Assume that we need to identify the spoiling activity of the foreign agent in the information network (for example, when analysing messages from a forum). Since the semantic analysis by the software tools is far behind of the human capabilities, then we set the task —collect statistics on users based on the criteria available for the application (length of messages, number of functional words, use of emotionally significant words, as well as estimate expressions, frequency index of words in messages, appearing in title and introductory article of the topic, number of words in common with the previous posting, as well as with the last the longest posting in the topic, etc.). Upon which each login (sequence of numbers) is compared by pairs with the previous one. For example, correlation is computed. Upon which the same data is tested for dispersion (root-mean-square spacing between the rows). Furthermore, the expert system receives task—to identify those users, who correlate the least with the others, but the data pairs with their participation ensure the maximum dispersion. At the same time, all obtained values on this user are summarized (results of all pairs, in which this user is present), i.e. the user itself listens to no one, but breaches the stability. Whereupon not all of its posts are taken for analysis, but they are split into the minimally possible for data sampling blocks, and one of them is selected, which destabilizes the system in the maximum degree and correlates the least with the principal ones. This message is submitted for analysis to human operator, who interacts with the ES. However the task set for the expert system can be different, for example: identifying the persons who have multiple logins. In this event the data can be supplemented, and if even this leads to no avail, they will be supplemented with either new features, or old ones with additional parameters (for instance, the number of same elements in different rows can be considered). And naturally, the expert system's actions algorithm will change. In this event it has to identify those pairs, which have the biggest amount of identical elements, and at the same time the highest correlation factor among them. In doing so, in contrast to the previous example, the pairs values are simply considered, and the highest of them are selected. The main problem in such cases lays in the fact that some categories of concepts (users) or links among them, in spite of their certainty, significance and strong impact on situation, have no generally accepted designation.

At stage 7), data pairs are determined, which during the processing by different functions provide either close or predictable result, determined as linked, and subsequently are used to build the object model. The values obtained at stage 6) (step 14) concerning the links between the studied object elements are subjected to normalization (step 15) pursuant to links norming rules (step 16). At stage 8), the following information is determined: which functions have been applied to analyse the links between the parts of the modelled object, which links between the parts thereof are the strongest, which links are generated by the largest number of functions that differ the most from each other, which concept is the most frequently present in the upper and lower positions of the pairs list sorted by values of various functions, distribution function nature for different concepts; and correlated and non-significant properties are identified. The normalized values for the links among elements of the studied object undergo the analysis procedure (step 17) by applying the set analysis rules (step 18) that may be adaptively variated in the course of the iterative process of the studied object model building. The purpose of analysis consists in the identification of links (step 18) between the object elements, for example, “controlling links”, “stabilizing links”, “central links”, that are the links, the value of which is critical in the obtained model (step 19) of the studied object, whereas in the final model of the studied object the “non-operating” links can be rejected as insignificant, which is expressed in their “disconnection” at the respective neurons of the ANN. The non-significance of links for the object model is determined by the nature of the processed functions, as well as by the set task.

The critical data is deemed to be the data, which underwent the filtration procedure and are present in the results of processing by various functions, for instance, the group of functions determining the link of data types proximity includes correlation, relationship, root-mean-square space, interval, and if at least two of these functions contain matching data pairs, which passed the upper threshold filtration, then these data is considered as critical for this type of links. For building of the object model the most significant ones are the “utmost indicators” (for example, the highest and the lowest correlation factor), and namely they characterize the object's link with the other ones. However, if we consider several different methods of data processing, then depending on the set task we can modify the norming rules. At the same time, the result can be obtained at which the evaluation criteria could be so stringent, that either nothing or half of the data will get there. Therefore the filter is made dynamic, and the value range changes until the near set number of objects remains. The main objective of the referenced filter consists in identifying groups of concepts with the least root-mean-square space between them. That is, the data is put into the n-dimensional space (where n is the number of functions), and “aggregation areas” are considered. The filter sets the criteria of areas limits that usually happen to be fuzzy.

Next, the intermediary model of the studied object is built (step 20), and its verification (step 21) subject to its compliance by way of comparing of the predictable and actual data of the object pursuant to the compliance verification rules (step 22), which can be adaptively changed in the iterative process of the studied object model building. Most often the compliance verification is performed by comparing the results obtained by different methods. At stage 9), they determine, if the obtained model provides a predictable result, then it is deemed as created; if the obtained result does not meet the imposed requirements, then it is deemed preliminary and used to modify the rules of ungrouping, estimation of properties, selection of functions for processing, and filtering criteria; if there is no result, then the number of properties and accuracy of their evaluation are analysed, and specific functions of data pairs processing are replaced with the standard ones. The intermediary model of the studied object is checked for the compliance with verification criteria, and if the intermediary model passes it, then this model becomes the final model of the studied object; if the intermediary model does not meet the verification criteria, then the amendments are made in the referenced rules. There are not thus many reasons that do not allow to the artificial intuition methods to build the correct model of object or phenomenon. And if this occurs, then the following options are checked: a) lack of data, b) inaccuracy of data, c) application of processing functions that do not meet the designated target, d) incorrect data filtering criteria, e) inappropriate setting for the expert system, which sets the selection criteria of critical links. When the sets of rules are modified, the process of obtaining object model starts again until the final (ready) studied object model is obtained.

The analysis of temporal series uses prediction verification by look back analysis. When studying applicability of specific functions of comparison and data cleaning technology, typically those processes are checked that can be re-tested by means of standard technologies, for instance, in an experimental way. When the object model building is in progress, predictions of its development are made, as well as the links between other objects are computed. A part of predictions can be filtered out, as generally known and apparently predetermined. However some statuses of the model become known only some time later due to the lack of required data. Some of the data can be re-tested by creating specific conditions. All these opportunities are used to check the model's conformity with the phenomenon and real process. If the conformity is below of the predetermined value, then the new model is built based on the new treatment functions and/or applying of the new filtration mechanics. However, most often it is enough to change the significance and reliability of some evaluations. The input data themselves are modified only in the case when the mentioned operations provided no result. Occasionally, the need of adjustment and supplement occurs, but the “old” data is not excluded from the processing as the “non-operating” data is filtered out automatically, and the fact itself that some of the data is not “critical” sometimes has a great significance for the figuring out of the widely spread and generally accepted deceptions regarding the process logic, or availability of the declared logic, which is an important factor for the solution of a number of tasks. The common criterion of testing remains the “predictability”, that is the degree of conformity of the model and object's behaviour, and not the coincidences (that is the occurrence of similar parts and degrees of their interoperability) of the model and object. The tasks of this kind are usually solved by the means of artificial (and natural) intelligence. The artificial intuition does not consider the inner logic of the process, although using this approach we can determine which of the logical schemes is the most efficient, as they usually provide lesser dispersion between various functions.

The above mentioned method is implemented by its realization within the machine readable environment, assisted by the system of object model building. This system can be implemented on the basis of widely known electronic computing machines (ECM), such as IBM PC. The system includes one or more processors, and one or more memory devices. The following devices can be used, without limitation, as referred memory devices: random access memory (RAM), read only memory (ROM), flash drives, HDD drive, SSD drive, USB drives, optical data disks (ODD), etc. The present method can be implemented in the form of machine readable instructions stored in the ECM memory, and executed by one or more processors of the ECM.

The main criterion of advantage of this method is not the volume of the extracted information, but its quality. The method allows to simplify and speed up the creation of a synthesizable object model for interpretation (including the visual one), and along this it makes it possible to concentrate the attention on the hidden object regularities, which are of interest for the observer. The object model synthesized by the present method is substantially less sensitive to the object data, that is why the requirements for data obtaining conditions are reduced during its implementation. The important thing is that in most cases the object model synthesized by the artificial intuition computer model is compact, which makes it possible to use it in a wide range of devices that have limitations concerning their computation capabilities.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of object model computer creation, comprising the steps of:
1) splitting a referenced object into parts, which are the concepts that have identical data sets describing their characteristics, wherein the concepts are formed on the basis of predetermined rules of ungrouping and, if required, the concepts containing the identical or close property values are reduced;
2) obtaining primary data, which represents all existing pairs of the referenced object parts in the amount of (n*n)/2−n, wherein n represents the number of parts;
3) evaluating and optimizing a number of properties, including those that describe the referenced parts of the object are performed;
4) functionally processing the obtained rows, wherein a standard set of functions is used including correlation or root-mean-square difference or specific functions arising out of task setting logic are applied;
5) sorting and grouping obtained results, wherein the grouped data is verified subject to their redundancy, and then the procedure of grouped data normalisation is executed, during which the redundant data is filtered out;
6) building functional links between the normalised grouped data obtained by different ways applying intellectual processing with the use of an expert system operation;
7) determining data pairs, which when processed by various functions provide a close or predictable result, as linked and subsequently are used for object model building;
8) determining which functions have been applied to analyse the links between the parts of the modelled object, which links between the parts thereof are the strongest, which links are generated by the largest number of functions that differ the most from each other, which concept is the most frequently present in the upper and lower positions of the pairs list sorted by values of various functions, distribution function nature for different concepts, and correlated and non-significant properties are identified; and
9) determining if the obtained model provides a predictable result, then it is deemed as created, if the obtained result does not meet the imposed requirements, then it is deemed preliminary and used to modify the rules of ungrouping, estimation of properties, selection of functions for processing, and filtering criteria, if there is no result, then the number of properties and accuracy of their evaluation are analysed, and specific functions of data pairs processing are replaced with the standard ones.

2. The method of claim 1, wherein an artificial neural network is used at stage 5).

3. The method of claim 2, wherein the rules of data cooperative processing for the expert system and artificial neural network are applied.

4. The method of claim 2, wherein the artificial neural network has an optimised architecture for accumulation of processing results for the purpose of establishing the dependencies and regularities between the distribution of different functions results values at different parameters and fixed data.

5. The method of claim 1, wherein the rules of cleaning, rules of grouping, rules of data cooperative processing for the expert system, rules of norming and rules of analysis are developed with the possibility make an adapted change during the iterative process of the studied object model building.

6. A system of object model computer creation containing at least one or more processors, and at least one memory device, where at least one memory device stores machine-readable instructions, which, if executed by at least one processor, stimulate the processor to execute the method of the object model creation according to claim 1.
